(19) United States
(12) Patent Application Publication
(10) Pub. No.: US 2007/0279326 A1
(43) Pub. Date: Dec. 6, 2007

(54) PLASMA DISPLAY PANEL DEVICE

(75) Inventor: Kwang-Jin Jeong, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/735,032

(22) Filed: Apr. 13, 2007

(30) Foreign Application Priority Data
May 2, 2006 (KR) 2006-39554

(51) Int. Cl. G09G 3/28

(52) U.S. Cl. 345/60

(57) ABSTRACT

A plasma display panel device including a plasma display panel forming an image, a plurality of fixing devices attached to the rear of the plasma display panel via an adhesive member, a plurality of board units applying an electrical signal to patterned discharge electrodes in the plasma display panel, and a case accommodating the plasma display panel and the board units.

### CROSS-REFERENCE TO RELATED APPLICATION

This application claims the benefit of Korean Patent Application No. 2006-39554, filed on May 2, 2006 in the Korean Intellectual Property Office, the disclosure of which is incorporated herein in its entirety by reference.

### BACKGROUND OF THE INVENTION

1. Field of the Invention

An aspect of the present invention relates to a plasma display panel device, and, more particularly, to a plasma display panel device in which a fixing member is adhered to a plasma display panel to reduce manufacturing costs.

2. Description of the Related Art

Conventionally, plasma display panels are flat display devices that display desired numbers, letters, or graphics by sealing a discharged gas in a space between two substrates on which a plurality of electrodes are formed, applying a predetermined discharge voltage, applying an appropriate pulse voltage if gas in discharge cells emits light due to the discharge voltage, and addressing a point where two electrodes cross each other.

FIG. 1 is a cross-sectional view of a conventional plasma display panel 100. The plasma display panel 100 comprises a panel 101, a chassis 102 formed to the rear of the panel 101, a driving circuit unit 103 formed in the chassis 102, a filter 104 formed in the front of the chassis, and a case 105 including the panel 101, the chassis 102, the driving circuit unit 103, and the filter 104. Here, the panel 101 is assembled and the chassis 102 is combined to the rear of the panel 101. The driving circuit unit 103 that transfers an electrical signal to a discharge electrode of the panel 101 is formed in the rear of the chassis 102. The panel 101, the chassis 102, and the driving circuit unit 103 are installed in the case 105.

However, the prices of liquid display devices, which are rival flat display devices that have a large size and which are mass-produced, have rapidly dropped. Therefore, among various proposed ideas to provide for a decrease in the price of the plasma display panel device 100, a driving method applied to a discharge electrode is improved so as to reduce the number of driving circuit units. Thus, improving the structure of equipment combined with the driving circuit units is necessary.

### SUMMARY OF THE INVENTION

An aspect of the present invention provides a plasma display panel device in which a fixing member is adhered to the rear of a plasma display panel to reduce manufacturing costs.

According to an aspect of the present invention, there is provided a plasma display panel device comprising: a plasma display panel to form an image; and a plurality of fixing devices attached to the rear of the plasma display panel via an adhesive member. The fixing device may be bosses used to fix the plasma display panel.

According to an aspect of the present invention, a plurality of board units may be formed in an area of the plasma display panel in order to apply an electrical signal to patterned discharge electrodes in the plasma display panel. The board units may be disposed in the chassis, and the chassis may be adhered to the rear of the plasma display panel via the adhesive member.

According to an aspect of the present invention, a thermal conductive sheet may be adhered to the rear of the plasma display panel in positions where the fixing devices are not formed. Also, an electromagnetic waves sheet may be adhered to the rear of the plasma display panel in positions where the fixing devices are not formed.

According to another aspect of the present invention, there is provided a plasma display panel device comprising: a plasma display panel to form an image; a plurality of fixing devices attached to the rear of the plasma display panel via an adhesive member; a plurality of board units to apply an electrical signal to patterned discharge electrodes in the plasma display panel; and a case to accommodate the plasma display panel and the board units.

According to an aspect of the present invention, the fixing devices may be a plurality of bosses used to fix the plasma display panel.

According to an aspect of the present invention, the bosses may be inserted into a plurality of boss holes formed in the case so as to adhere the plasma display panel to external equipment.

According to an aspect of the present invention, a thermal conductive sheet may be adhered to the rear of the plasma display panel in positions where the fixing devices are not formed.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a conventional plasma display panel;

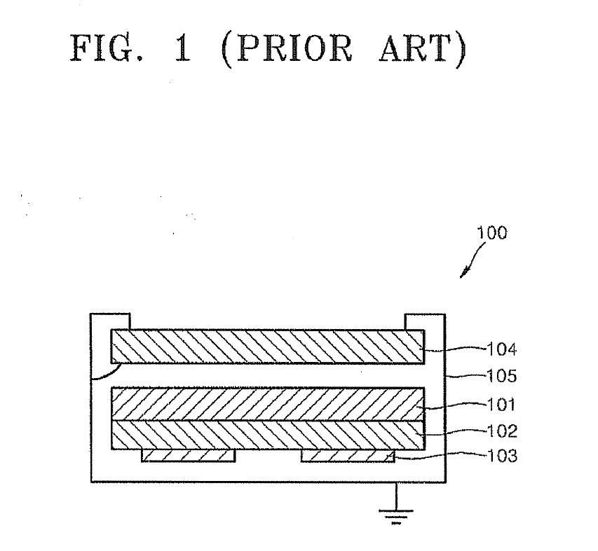

FIG. 2 is a partially cutaway exploded perspective view of a plasma display panel device according to an embodiment of the present invention;

FIG. 3 is an enlarged diagram of a fixing device illustrated in FIG. 2; and

FIG. 4 is a partially cutaway exploded perspective view of a plasma display panel device according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

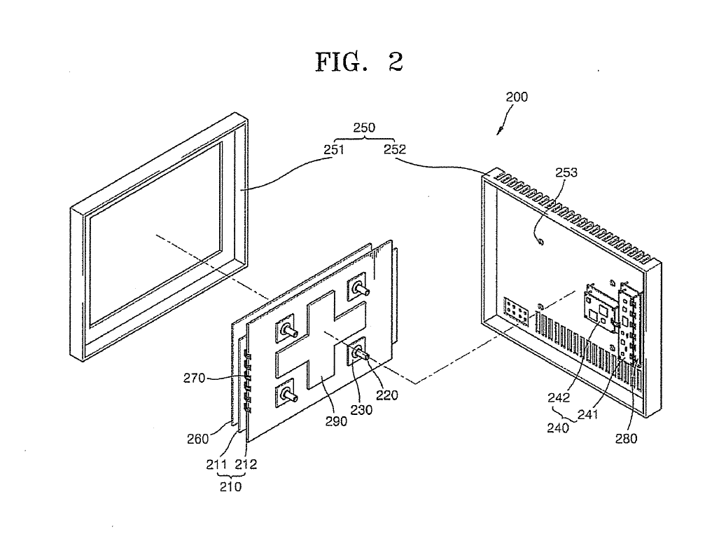

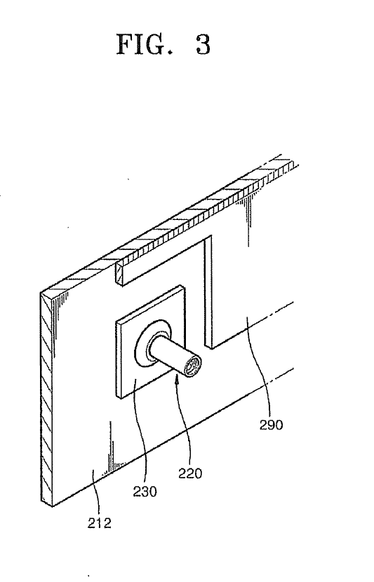

FIG. 2 is a partially cutaway exploded perspective view of a plasma display panel device 200 according to an embodiment of the present invention. FIG. 3 is an enlarged diagram of the fixing device illustrated in FIG. 2. As shown in FIGS. 2 and 3, the plasma display panel device 200 comprises a plasma display panel 210. Fixing devices are adhered to the plasma display panel 210 and to the board units 240 that apply an electrical signal to patterned discharge electrodes of the plasma display panel 210. A case 250 accommodates the plasma display panel 210 and the board units 240. The plasma display panel 210 includes a first substrate 211 and a second substrate 212 to face the first substrate 211. The first substrate 211 has one set of the patterned electrodes, and the second substrate 212 has another set of electrodes disposed opposite the one set of electrodes to generate an image when driven by the board units 240. The another set of electrodes is disposed on a front of the second substrate 212.

The fixing devices are adhered to the rear of the second substrate 212 via an adhesive member 230. According to an embodiment of the invention, the fixing devices comprise a plurality of boss units 220 that allow the plasma display panel 210 to hang onto a wall or to adhere to an external area. The boss units 220 are separately disposed in four corner portions of the plasma display panel 210 in order to spread forces applied to the plasma display panel 210 when the plasma display panel 210 is displayed. Although the fixing devices have been described as boss units, it is understood that other devices may be employed to similar effect. Moreover, while shown as four boss units 220, it is understood that other numbers of boss units 220 may be used and need not be used symmetrically as shown.

The boss units 220 include screw grooves to allow for screw coupling of the boss units 220 in this embodiment. However, the boss units 220 are not limited thereto and may comprise a bracket coupling if the boss units 220 are to be used to adhere the plasma display panel 210 to the external area or to detach the plasma display panel 100 from the external area. Further, it is understood that all of the boss units 220 need not be used to secure the panel 200 to the external area in all aspects of the invention.

The adhesive member 230 is disposed between the second substrate 212 and the boss units 220 to adhere the boss units 220 to the rear of the second substrate 212. The adhesive member 230 may be an epoxy and/or double-sided tape or other like adhesive, fastener, or glue whose adhesive force prevents the boss units 220 from being undesirably detached from the plasma display panel 210.

The case 250 includes a front cabinet 251 formed in the front of the plasma display panel 210 and a back cover 252 formed in the rear of the panel 210. The boss units 220 are inserted into the back cover 252 to form boss holes 253 that establish the location of the boss units 220. The boss holes 253, therefore, are formed in the back cover 252 to correspond in position to the boss units 220 so that the boss units 220 are projected through the boss holes 253.

Each of the board units 240 includes a driving unit 241 that applies an electrical signal to the patterned discharge electrode (not shown) of the plasma display panel 210 via a signal transfer unit 270, and a power supply unit 242 that supplies power from an exterior of the plasma display panel device 200. The driving unit 241 includes circuitry to apply the electrical signal to each discharge electrode. According to an embodiment of the invention, the power supply unit 242 includes an image processor that converts an external analog image signal into a digital signal and a logical controller. The logical controller receives an internal image signal processed by the image processor and outputs a control signal. According to another embodiment of the invention, the power supply unit 242 includes circuitry in which the image processor, the logical controller, the driving unit 241, and the power supply unit 242 are distributed.

The board units 240 are installed in a chassis 280 that adheres to the back cover 252. According to an embodiment of the invention, the board units 240 may also be disposed in the back cover 252 without the chassis 280. A member 290, such as a thermal conductive sheet or an electromagnetic shielding sheet, may be additionally formed in the rear of the second substrate 212 at positions of the second substrate 212 at which the board units 240 are not formed. However, it is understood that the member 290 need not be used in all aspects of the invention.

When the member 290 comprises a thermal conductive sheet, the thermal conductive sheet may be formed of a highly efficient heatproof material such as graphite in order to improve characteristics of an afterimage of the plasma display panel 210. Such improvements are due to the thermal conductive sheet being able to quickly dissipate heat that is generated from the plasma display panel 210 when the plasma display panel 210 is driven. When the member 290 is an electromagnetic shielding sheet, a metal net or a metal sheet having high characteristic conductivity may be employed to shield electromagnetic waves.

A filter 260 is attached to the front of the plasma display panel 210. The filter 260 is formed of a plurality of films. The filter 260 includes an anti-reflection (AR) film that prevents a drop in visible recognition due to the reflection of the external light, an electromagnetic shielding filter that effectively shields electromagnetic waves generated when the plasma display panel 210 is driven, and a selective wavelength absorption film that shields neon luminescence in a 590 nanometer area and unnecessary luminescence of near infrared rays caused by plasma of inactive gas used to emit light from a screen. The filter 260 may include additional films having various additional functions. However, it is understood that the filter 260 need not be used or can be otherwise disposed in other aspects of the invention.

The plasma display panel device 200, having the above structure, is generally understood to be manufactured with the plasma display panel 210 comprising the first substrate 211 and the second substrate 212. The plurality of boss units 220 are fixed to the rear surface of the second substrate 212. The plurality of board units 240 are mounted in the chassis 280 or directly to appropriate positions on the back cover 252. If the board units 240 are mounted in the chassis 280, the chassis 280 is fixed to appropriate positions on the inner surface of the back cover 252. When the front cabinet 251 and the back cover 252, disposed in the front and rear of the plasma display panel 210, respectively, are combined with each other, the boss units 220 are inserted into the boss holes 253 formed in the back cover 252. The plasma display panel device 200 is then fixed to external fixing equipment or combined with a stand.

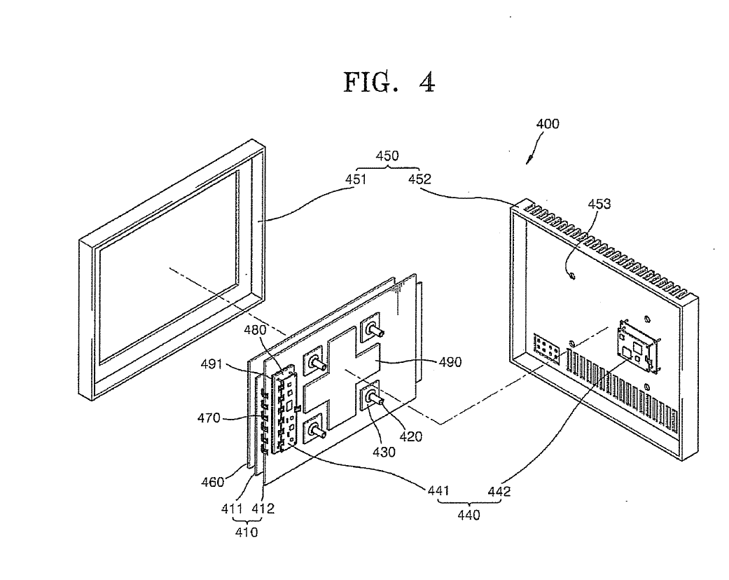

FIG. 4 is a partially cutaway exploded perspective view of a plasma display panel device 400 according to another embodiment of the present invention. As shown in FIG. 4, the plasma display panel device 400 includes a plasma display panel 410 comprising a first substrate 411 and a second substrate 412 disposed to face the first substrate 411.

A plurality of boss units 420 are attached to the rear of the second substrate 412 via an adhesive member 430. The boss units 420 are formed in various positions of the second substrate 412 to disperse forces applied to the second substrate 412 or to disperse force applied to areas which are relatively vulnerable to damage. The positions of the boss units 420 are not limited thereto, however. A member 490 such as a thermal conductive sheet and/or an electromagnetic sheet is attached to positions of the second substrate 412 at which the boss units 420 are not formed.

The plasma display panel 410 is included in the case 450. The case 450 comprises a front case 451 and a back cover 452 combined together. The boss units 420 are inserted into the back cover 452 to form boss holes 453 so as to be able to fix the location of the boss units 420.

A plurality of board units 440 are formed to apply an electrical signal to patterned discharge electrodes of the plasma display panel 410 via a signal transfer unit 470 and supplied power. The board units 440 include a driving unit 441 and a power supply unit 442. The driving unit 441 is formed in a chassis 480 that is fixed to an area in the rear of the second substrate 412 via the adhesive member 491. The power supply unit 442 is formed in the back cover 452. Alternatively, the power supply unit 442 may be fixed to an area in the rear of the second substrate 412, and the driving unit 441 may be formed in the back cover 452. As a further alternative, the driving unit 441 and the power supply unit 442 may be fixed to an area in the rear of the second substrate 412. A filter 460 is attached to the front of the first substrate 411.

The plasma display panel device according to aspects of the present invention has at least one or more of the following advantages. First, a fixing device, such as a boss, is attached to a plasma display panel, which does not require a chassis, thereby reducing manufacturing costs. Second, the number of board units applied to discharge electrodes of the plasma display panel is reduced so that structures suitable for the board units may be designed, thereby reducing manufacturing processes.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A plasma display panel device comprising:
a plasma display panel having patterned discharge electrodes for forming an image;
an adhesive member; and
a plurality of fixing devices attached to a rear of the plasma display panel via the adhesive member.

2. The plasma display panel device of claim 1, wherein the fixing devices comprise bosses used to fix the plasma display panel to an external holder.

3. The plasma display panel device of claim 1, wherein the adhesive member comprises epoxy.

4. The plasma display panel device of claim 1, wherein the adhesive member comprises double-sided tape.

5. The plasma display panel device of claim 1, further comprising a plurality of board units formed in an area of the plasma display panel in order to apply an electrical signal to the patterned discharge electrodes of the plasma display panel.

6. The plasma display panel device of claim 5, further comprising a chassis, wherein the board units are disposed in a chassis, and the chassis is adhered to the rear of the plasma display panel via the adhesive member.

7. The plasma display panel device of claim 1, further comprising a thermal conductive sheet adhered to the rear of the plasma display panel in areas where the fixing devices are not formed.

8. The plasma display panel device of claim 7, wherein the thermal conductive sheet comprises graphite.

9. The plasma display panel device of claim 1, further comprising an electromagnetic waves sheet adhered to the rear of the plasma display panel in areas where the fixing devices are not formed.

10. A plasma display panel device comprising:
a plasma display panel having patterned discharge electrodes for forming an image;
an adhesive member;
a plurality of fixing devices attached to a rear of the plasma display panel via the adhesive member;
a plurality of board units applying an electrical signal to the patterned discharge electrodes in the plasma display panel; and
a case accommodating the plasma display panel and the board units.

11. The plasma display panel device according to claim 10, wherein the fixing devices comprise a plurality of bosses used to fix the plasma display panel.

12. The plasma display panel device according to claim 10, wherein the bosses are inserted into a plurality of boss holes formed in the case to allow the plasma display panel to be attached to external equipment.

13. The plasma display panel device according to claim 10, wherein the adhesive member comprises epoxy.

14. The plasma display panel device according to claim 10, wherein the adhesive member comprises double-sided tape.

15. The plasma display panel device according to claim 10, wherein some of the board units are formed in the plasma display panel and other board units are formed in the case.

16. The plasma display panel device according to claim 15, wherein the board units are disposed in a chassis that is adhered to an area of the plasma display panel via the adhesive member.

17. The plasma display panel device according to claim 10, wherein a thermal conductive sheet is adhered to the rear of the plasma display panel at positions where the fixing devices are not formed.

18. The plasma display panel device according to claim 10, wherein an electromagnetic waves sheet is adhered to the rear of the plasma display panel at positions where the fixing devices are not formed.

19. The plasma display panel device according to claim 10, wherein an electromagnetic shielding filter is attached to the front of the plasma display panel.
